(19) United States
(12) Patent Application Publication
(10) Pub. No.: US 2005/0165871 A1
(43) Pub. Date: Jul. 28, 2005

(54) Method and apparatus for recycling application processes

(75) Inventors: John William Barrs II, Austin, TX (US); Jerry Walter Malcolm, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/756,128

(22) Filed: Jan. 13, 2004

(51) Int. Cl. G06F 17/30

(52) U.S. Cl. 707/205

(57) ABSTRACT

A method, apparatus, and computer instructions for saving session data. Session data associated with an application in a file is placed in a location, such as a recycle bin or other container or folder, to form a stored file in response to a closing of a session for the application. An appropriate file name is associated to identify a specific instance of the session that has been packaged and stored in a recycle bin.

### BACKGROUND OF THE INVENTION

1. Technical Field

The present invention relates generally to an improved data processing system and in particular to a method and apparatus for managing data. Still more particularly, the present invention relates to a method, apparatus, and computer instructions for storing files from application sessions.

2. Description of Related Art

Computers are pervasive in today's society. Computers have many uses at work and at home. Users employ computers to design hardware and software systems as well as analyze those systems. Further, computers are used to generate documents and provide communications in both business and personal uses. A myriad of programs are available for users to perform almost any task. These programs include, for example, word processors, spreadsheet programs, computer aided design (CAD), compilers, and Web design programs.

Often times, a program, such as a word processor, is accidentally closed. When the program is closed through normal means, the information is lost. For example, when a user closes a word processing program, the program may prompt the user to save changes. If the user accidentally decides not to save the changes, those changes are lost. Additionally, other information in the program is lost. For example, information that may be used to undo or redo edits is lost.

In other situations, a document is edited several times and the changes are made and saved to disk that the user desires to undo. For example, a user creating a report with a word processor may delete a number of paragraphs and save those changes. If the user then desires to restore those paragraphs, the user is unable to recover those deleted paragraphs. With the current technology and standard operating system techniques, once a program is closed, only the persistent data stored on the disk by the individual application remains available for use.

Many applications, including word processors, may provide a backup system in which a backup of a file is made during a session periodically, such as every five minutes or every ten minutes. A session begins when the user initiates or executes an application and ends when the user closes the application through normal means. In some cases, a word processor may provide a backup in which a previous file is saved under another file name when the current document is saved. Such a system, however, does not provide the user any mechanism to recover data that has been taken out during several different edits with changes being saved to the disk during the session. Additionally, other information such as information used to undo edits is not saved to the disk. This information is lost when the user exits the application.

It would be advantageous to have an improved method, apparatus, and computer instructions for allowing a user to restore information from a program session.

### SUMMARY OF THE INVENTION

The present invention provides a method, apparatus, and computer instructions for saving session data. Session data associated with an application in a file is placed in a location, such as a recycle bin or other container or folder, to form a stored file in response to a closing of a session for the application. An appropriate file name is associated to identify a specific instance of the session that has been packaged and stored in a recycle bin.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in recycling or restoring sessions for an application in accordance with a preferred embodiment of the present invention;

FIG. 4 is a diagram of an archive file in accordance with a preferred embodiment of the present invention;

FIG. 5 is a diagram illustrating a recycle bin with an archive file in accordance with a preferred embodiment of the present invention;

FIG. 6 is a flowchart of a process for saving a session in accordance with a preferred embodiment of the present invention; and

FIG. 7 is a flowchart of a process for restoring a session in accordance with a preferred embodiment of the present invention.

### DETAILED DESCRIPTION OF THE PREFERRED EMBODIMENT

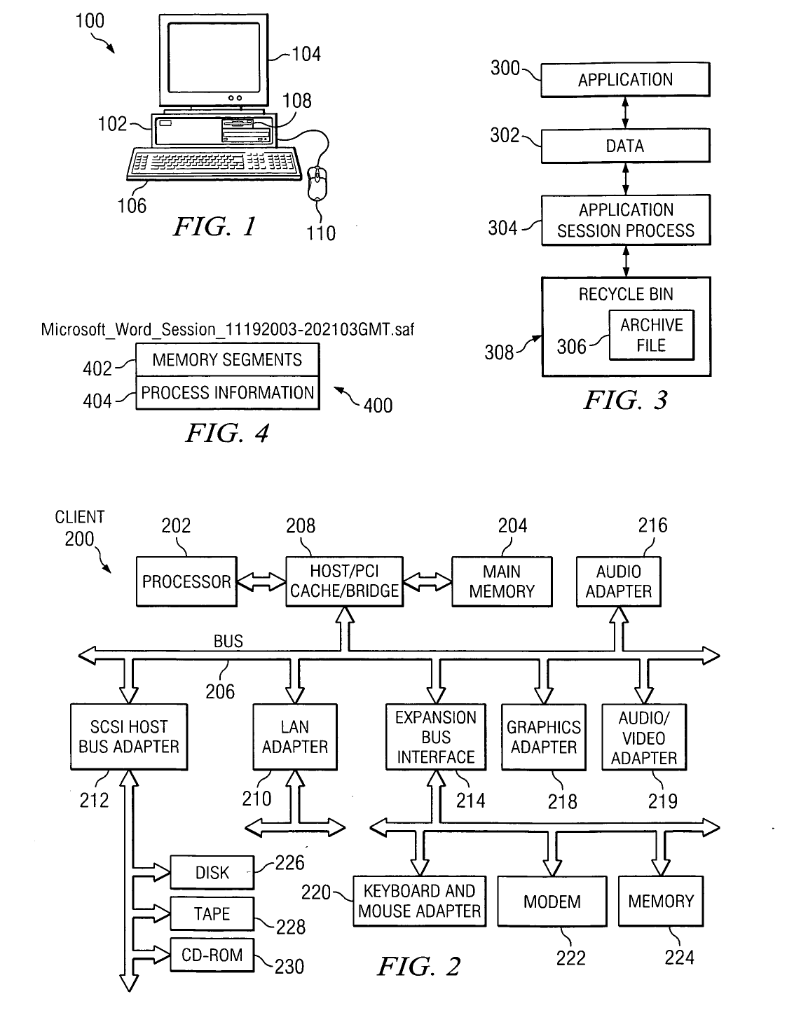

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a method, apparatus, and computer instructions for allowing a user to restore a session for an application. Upon closing a session or an indication to save data to a permanent storage, the data for the session is stored in a file. This file is stored in a persistent storage in an appropriate location, such as in a recycle bin with an identification to identify the specific instance of a stored file. A selection of the file in the recycle bin causes the session for the application to be restored using the information in the stored file.

In an illustrative embodiment, a user may indicate the closing or termination of a session through various user inputs. For example, a user may select an exit menu option or close the window in which the application is executing. Additionally, the user may press some combination of keys, such as alt-F4. In this illustrative embodiment, memory segments and process information related to the session are collected by the operating system. This information is packaged into an archive file suitable for complete recovery and restart of the session at a later time. That file is placed on the hard drive in a location, such as the recycle bin for the operating system with an appropriate identification.

As used herein, a recycle bin is a utility for storing files that are to be deleted. With this recycle bin, files are recoverable until the recycle bin is emptied. In the examples shown in the figures, the location for the archive file is depicted as being located in a recycle bin for purposes of illustration. Depending on the particular implementation, the archive file may be placed in other locations, such as other folders or bins. In fact, any type of paradigm that allows for a user to locate an archive file and select the archive file to restore a session may be used.

In the illustrative examples, these archive files containing the session data are stored in the recycle bin. Consequently, at any time in the future prior to emptying of the recycle bin, a user may simply open the item in the recycle bin to restore the session. In these illustrative examples, the existing operating system recycle bin may be used, or another separate bin offering similar function. The operating system uses the session information stored in the archive file to recreate the session at the identical point when the session was previously closed. Further, the creation of an archive file for recovery of a session also may be made in response to a command generated by the user to store data in a persistent or permanent storage.

With reference now to FIG. 3, a diagram illustrating components used in recycling or restoring sessions for an application is depicted in accordance with a preferred embodiment of the present invention. Application 300 currently has data 302, which is generated during a session for application 300.

In the illustrative examples, a session begins when a user initiates execution of application 300 and ends when the user closes application 300. In response to a closing of the session or an indication that data is to be saved to a persistent or permanent storage, application session process 304 takes data 302 and creates archive file 306. In these illustrative examples, this archive file is stored in a persistent storage, such as on a hard drive, in an appropriate location, such as within recycle bin 308. As used herein, a recycle bin is any process, utility, or function that is used to hold files deleted by a user in a manner that may be recovered prior to the files being emptied from the recycle bin. Data 302, in the illustrative example, includes all of the information needed to restore the session at the identical point when the session is closed or at the identical point when data is saved to a permanent or persistent storage. Data 302 includes, for example, data located in various memory segments in the data processing system as well as process information related to the session.

Turning now to FIG. 4, a diagram of an archive file is depicted in accordance with a preferred embodiment of the present invention. File 400 is an example of an archive file, such as archive file 306 in FIG. 3. In this illustrative example, file 400 contains memory segments 402 and process information 404. File 400 is identified as

“Microsoft_Word_Session_{—}11192003-202103GMT.saf” in this illustrative example.

Memory segments 402 may include both code segments and data segments. The code segments are the portions of the memory that contain the code used to execute the application. The data segments include all the information created or used by the application. This data may include, for example, the documents that are being worked on and any information used to undo or restore edits made to the document. In the illustrative example, memory segments 402 only contain the data segments.

The code segments may be included, depending on the implementation. Inclusion of this information may be useful in case the user has deleted or removed the program from the data processing system. With the code segments, the user may still be able to view and edit the file for the application session.

Process information 404 includes all of the information needed to recreate the environment for the session. This information may include, for example, register states in a processor and an identification of threads used to run the application. In these illustrative examples, the information may be, but is not required to be an instantaneous snapshot that could occur at any microsecond. In the illustrative embodiment, the operating system allows allow certain tasks to complete before the capturing of process information 404 to allow for a cleaner restart. In other words, the information saved for process information 404 is everything needed for an adequate restart and restore to an acceptable point in the application execution process such that relevant data is available as it was prior to close. Process information 404 may be obtained through processes similar to those used in hibernating data processing systems.

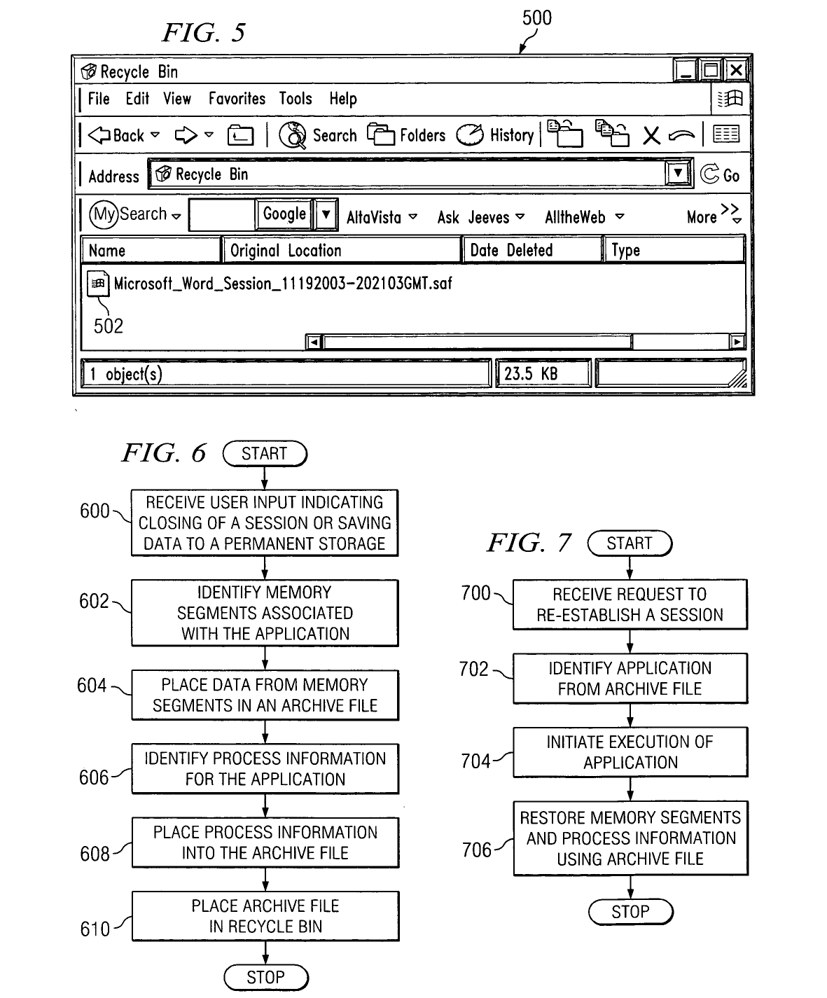

With reference now to FIG. 5, a diagram illustrating a recycle bin with an archive file is depicted in accordance with a preferred embodiment of the present invention. In this illustrative example, recycle bin 500 contains archive file 502. Archive file 502 is identified as “Microsoft_Word_Session_{—}11192003-202103GMT.saf”. A user may restore the session for an application by opening archive file 502 in recycle bin 500.

Turning now to FIG. 6, a flowchart of a process for saving a session is depicted in accordance with a preferred embodiment of the present invention. The process illustrated in FIG. 6 may be implemented in an operating system process, such as application session process 304 in FIG. 3.

The process begins by receiving a user input indicating the closing of a session or saving data to a permanent storage (step 600). In response to this user input, memory segments associated with the application are identified (step 602). In this example, the memory segments identified are the data segments for the application.

Thereafter, the data from the memory segments is placed in an archive file (step 604). Next, process information for the application is identified (step 606). This process information also is placed into the archive file (step 608). This information is placed into the archive file in a manner suitable for restoring the session at a later time. Then, the archive file is placed in a suitable location, such as the recycle bin for the operating system (step 610) with the process terminating thereafter.

With reference now to FIG. 7, a flowchart of a process for restoring a session for an application is depicted in accordance with a preferred embodiment of the present invention. The process illustrated in FIG. 7 may be implemented in an operating system process, such as application session process 304 in FIG. 3.

The process begins by receiving a request to re-establish a session (step 700). This request, in these illustrative examples, takes the form of opening an archive file located in an appropriate location, such as file 502 in recycle bin 500 in FIG. 5. Next, an application is identified from the archive file (step 702). Afterwards, execution of the application is initiated (step 704). The memory segments and process information are restored using the archive file (step 706) with the process terminating thereafter. Step 706 basically restores the session for the application.

In this manner, the session for the application may be restored to the state at which the application was closed. For example, with a word processing application, a document and the undo information is restored for use by the user. Further, information stored in a clipboard during the session also is restored through the restoration of process information.

Thus, the present invention provides an improved method, apparatus, and computer instructions for saving and restoring sessions for an application. The mechanism of the present invention stores session data for a program in a file in a recycle bin in response to a closing of the session or program or in response to an indication that data is to be saved to a permanent or persistent storage. The archive file is placed in a persistent storage in a suitable location, such as the recycle bin. This archive file may be opened at a later time to restore the session.

In response to opening this file, the session data stored in the file is used to initiate execution of the program and place the program back into the same state as when the session information was saved. As a result, a user may undo changes to data, such as a document even though the document may have been edited several times with changes being made and saved to the hard drive. This restoration of sessions may occur as long as the archive files are not emptied from the recycle bin.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. In the illustrative examples, the location for the archive files is shown as being a recycle bin. Other types of locations may be used. For example, the mechanism of the process may be configures to send each archive file by email to some selected email address. In that case, a user may use an email program to locate the email message with the archive file, detach the attached archive file to a temporary directory, and select that file to restore that session for the application. The embodiment was chosen and described in order to best explain the principles of the invention, the practical application, and to enable others of ordinary skill in the art to understand the invention for various embodiments with various modifications as are suited to the particular use contemplated.

1. A method in a data processing system for saving session data, the method comprising:
responsive to a closing of a session for a program, placing session data associated with the program in a file in a selected location to form a stored file; and
associating an identification with the stored file to identify the stored file in the selected location.

2. The method of claim 1 further comprising:
responsive to an indication to save data generated using the program to a permanent storage, placing current session data associated with the program in another file in the selected location to form another stored file; and
associating another identification to identify the another stored file in the selected location.

3. The method of claim 1, wherein the session data includes memory segments related to the session for the program and process information related to the session for the program.

4. The method of claim 1, wherein the closing of the session of the program occurs in response to at least one of a selection of an exit menu option and a window close input.

5. The method of claim 1 further comprising:
responsive to a selection of the identification of the stored file in the selected location, restoring the session using the stored file.

6. The method of claim 5, wherein the restoring step includes:
initiating execution of the program using the session data in the stored file.

7. The method of claim 1, wherein the selected location is a location used to hold deleted files in a manner that allows for recovery of the deleted files at a later time.

8. A data processing system for saving session data, the data processing system comprising:
a bus system;
a communications unit connected to the bus system;
a memory connected to the bus system, wherein the memory includes a set of instructions; and
a processing unit connected to the bus system, wherein the processing unit executes the set of instructions to place session data associated with the program in a file in a selected location to form a stored file in response to a closing of a session for a program; and associate an identification to identify the stored file in the selected location.

9. A data processing system for saving session data, the data processing system comprising:
placing means, responsive to a closing of a session for a program, for placing session data associated with the program in a file in a selected location to form a stored file; and
associating means for associating an identification to identify the stored file in the selected location.

10. The data processing system of claim 9, wherein the placing means is a first placing means and the associating means is a first associating means and further comprising:
second placing means, responsive to an indication to save data generated using the program to a permanent storage, for placing current session data associated with the program in another file in the selected location to form another stored file; and
second associating means for associating another identification to identify the another stored file in the selected location.

11. The data processing system of claim 9, wherein the session data includes memory segments related to the session for the program and process information related to the session for the program.

12. The data processing system of claim 9, wherein the closing of the session of the program occurs in response to at least one of a selection of an exit menu option and a window close input.

13. The data processing system of claim 9 further comprising:
restoring means, responsive to a selection of the identification of the specific instance of the stored file in the selected location, for restoring the session using the stored file.

14. The data processing system of claim 13, wherein the restoring means includes:
initiating means for initiating execution of the program using the session data in the stored file.

15. A computer program product in a computer readable medium for saving session data, the computer program product comprising:
first instructions, responsive to a closing of a session for a program, for placing session data associated with the program in a file in a selected location to form a stored file; and
second instructions for associating an identification to identify the stored file in the selected location.

16. The computer program product of claim 15 further comprising:
third instructions, responsive to an indication to save data generated using the program to a permanent storage, for placing current session data associated with the program in another file in the selected location to form another stored file; and
fourth instructions for associating another identification to identify the another stored file in the selected location.

17. The computer program product of claim 15, wherein the session data includes memory segments related to the session for the program and process information related to the session for the program.

18. The computer program product of claim 15, wherein the closing of the session of the program occurs in response to at least one of a selection of an exit menu option and a window close input.

19. The computer program product of claim 15 further comprising:
sixth instructions, responsive to a selection of the identification of the specific instance of the stored file in the selected location, for restoring the session using the stored file.

20. The computer program product of claim 19, wherein the restoring step includes:
first sub-instructions for initiating execution of the program using the session data in the stored file.
